(19) United States
(12) Patent Application Publication
(10) Pub. No.: US 2021/0372194 A1
(43) Pub. Date: Dec. 2, 2021

(54) EXTRUSION PROFILE, METHOD FOR MANUFACTURING AN EXTRUSION PROFILE AND DOOR SYSTEM AND/OR WINDOW SYSTEM

(71) Applicant: Salamander Industrie-Produkte GmbH, Tuerkheim (DE)

(72) Inventor: Till Schmiedeknecht, Muenchen (DE)

(73) Assignee: Salamander Industrie-Produkte GmbH, Tuerkheim (DE)

(21) Appl. No.: 17/333,412

(22) Filed: May 28, 2021

(30) Foreign Application Priority Data
May 29, 2020 (DE) 102020114544.6

(51) Int. Cl. E06B 3/263; E06B 3/22

(52) U.S. Cl. CPC E06B 3/26345; E06B 2003/26378; E06B 3/22

(57) ABSTRACT

An extrusion profile of, for example, a polymer material, such as PVC, for a door system and/or window system, may include at least one hollow chamber extending in the extrusion direction, which is delimited by profile walls; and an insulation core of foam arranged in the at least one hollow chamber. The foam may have a compression strength of at least 0.3 N/mm².

### CROSS REFERENCE TO RELATED APPLICATIONS

This patent application claims priority to German Patent Application No. 102020114544.6, filed May 29, 2020, which is incorporated herein by reference in its entirety.

### BACKGROUND

### Field

The present disclosure relates to an extrusion profile, in particular made of a polymer material, such as Polyvinyl chloride (PVC), for a door system and/or a window system, for example of a passive house. Furthermore, the present disclosure also relates to a method for manufacturing an extrusion profile. Furthermore, the present disclosure provides a door system and/or a window system comprising an extrusion profile.

### Related Art

Typically, PVC extrusion profiles for windows and/or doors have both a steel stiffener structural reasons and to enable the screw connection of fittings, and an insulation filling of either PolyStyrene (PS) or Expanded PolyStyrene (EPS) to achieve a good heat transfer coefficient (U-value). For example, roll-formed steel profiles are used, which on the one hand provide the static features for the windows and at the same time serve as screw basis for the fittings. In order to achieve a significantly improved U-value, it is necessary to insert insulation foam material made of PS or EPS into the hollow chambers of the extrusion profile. For example, the insulation material is inserted into the steel stiffener in the hollow chambers of the extrusion profiles or they are completely filled with foam, so that the foam material engages into a firm connection with the extrusion profile. The use of steel profiles is also necessary in so far as they serve as a counter bearing for the screw connection in the masonry and the fittings.

DE 10 2008 00 495 A1 discloses such a known Polyurethane (PU) a window frame profile with the hollow chamber and a foam insulation material completely filling the same. Additional reinforcement elements in the form of stability-increasing fiber elements, cubes made of plastics or a fiber composite material or a fitting part are incorporated in the insulation material to ensure the required mechanical stability of the window frame profile. The reinforcing elements are already placed in the molding tool during the foaming of the foam insulation material and overmoulded by the foam. Subsequently, the foam insulation material stiffened with the reinforcement element is overmoulded by a rigid polyurethane sheathing in an injection molding process. Disadvantages of the known extrusion profiles are the complex production as well as the high number of components in order to ensure, on one hand, a sufficient strength or rigidity of the extrusion profiles and, on the other hand, a sufficient insulation effect.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1A, 1B a door system and/or a window system with an extrusion profile according to an exemplary embodiment of the disclosure.

FIG. 2A, 2B a door system and/or window system with an extrusion profile according to an exemplary embodiment of the disclosure.

FIG. 3A, 3B a door system and/or window system with an extrusion profile according to an exemplary embodiment of the disclosure.

FIG. 4A, 4B a door system and/or window system with an extrusion profile according to an exemplary embodiment of the disclosure.

FIG. 5A, 5B a door system and/or window system with an extrusion profile according to an exemplary embodiment of the disclosure.

FIG. 6A, 6B a door system and/or window system with an extrusion profile according to an exemplary embodiment of the disclosure.

FIG. 7A, 7B a door system and/or window system with an extrusion profile according to an exemplary embodiment of the disclosure.

FIG. 8A, 8B a door system and/or window system with an extrusion profile according to an exemplary embodiment of the disclosure.

FIG. 9 a door system and/or window system with an extrusion profile according to an exemplary embodiment of the disclosure.

FIGS. 10-15 cross-sectional views of extrusion profiles according to exemplary embodiments of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, have not been described in detail to avoid unnecessarily obscuring embodiments of the disclosure.

An object of the present disclosure is to overcome the disadvantages known in the prior art, including to provide an extrusion profile which is simpler and/or can be produced with fewer components, and which in particular has a right higher rigidity and/or better insulation effect.

Accordingly, an extrusion profile is provided for a door system and/or window system, in particular for a door frame and/or a window frame, for example of a passive house. The extrusion profile may for example be made of a polymer material, such as PVC. The extrusion profile is manufactured by an extrusion process which is cost-effective and energy efficient for large production volumes. The extrusion profile is defined by an extrusion direction which defines the longitudinal direction of the extrusion profile, in which the extrusion profile does not substantially change in cross-section. The extrusion profiles according to the disclosure can be used, for example, for door systems and/or window systems comprising a door profile frame and/or window profile frame, for example a frame profile of the pivoting or linear sliding sash, a frame profile of a stationary so-called fixed sash, a faceplate or a mullion, a profile frame, door frame and/or window frame in a building wall reception, such as a shroud profile, or complementarity frame parts, such as for example a lining profile or a shield profile.

The extrusion profile comprises at least one hollow chamber extending in the extrusion direction and delimited by profile walls. Furthermore, the extrusion profile comprises a plurality of hollow chambers extending in the extrusion direction and delimited by profile walls. Generally, the extrusion profile is largely hollow, but may have, in particular thin-walled, profile walls for delimiting and dividing the interior, which profile walls delimit the hollow chambers and/or connector profile wall forming the outside of the extrusion profile. A hollow chamber does not necessarily need to be completely closed in the circumferential direction but may in some cases be designed to be open by means of slates or larger openings. In an exemplary embodiment, the at least one hollow chamber is closed in the circumferential direction (around the longitudinal direction). For example, the at least one hollow chamber is open in the extrusion direction all longitudinal direction to at least one assigned, in particular to both sides.

According to the disclosure, an insulation core of foam material is arranged in the at least one hollow chamber, which core has a compressive strength of at least 0.3 N/mm². To determine the compressive strength, the standard test method according to ASTM D 1621 can be used, by means of which the compressive properties of rigid foams, in particular rigid polymer material foams, can be determined and tested. For example, the foam material is PET, in particular the material Kerdyn®, or a foam material having similar characteristic values, such as for example the foam known under the trademark ‘wingo-HT-Isolationsschaumstoff’ (wingo-HT-isolation foam). A significant advantage of using a foam insulation core with a minimum compressive strength of 0.3 N/mm² is that further stiffening measures, such as the steel stiffeners usually inserted into the hollow chambers, can be dispensed with. This is accompanied by further considerable advantages: reduced weight and thus costs, in particular freight costs, as well as easier assembly. The foam insulation core can be inserted into the hollow chamber in any way, for example by being pushed in. In particular, the use of a foam material according to the disclosure, such as the Polyethylene terephthalate (PET) foam, for example the Kerdyn® material, or the wingo-HT-isolation foam, for the insulation core has been found to be particularly advantageous for use in extrusion profiles according to the genus for door systems and/or window systems, for example in a passive house. PET is a thermoplastic from the polyester family produced by polycondensation. In general, the foam material according to the disclosure is a thermoplastic form material with high mechanical and thermal properties and a high resistance to moisture. As a result, the extrusion profile can meet the structural and rigidity requirements. Furthermore, the foam material according to an exemplary embodiment of the disclosure, in particular the PET-foam, preferably the Kerdyn® foam material, or the wingo-HT-isolation foam, is characterized by the high thermal insulation properties and the good fire behavior, so that especially a passive house can achieve a good insulation value. For example, the foam material may be foamed PET, in particular Kerdyn® foam material, in particular made of a recycled and/or recyclable polymer material, for example made of PET. A further advantage lies in the processing of the foam material according to the disclosure, in particular the PET foam material, such as the Kerdyn® foam material. This can be cut to size in a simple manner and, for example, attached to one another in any longitudinal direction, for example welded to butt, so that essentially no scrap or waste is produced. Surprisingly, it has been shown that when arranging a foam insulation core with the minimum compressive strength of 0.3 N/mm², an extrusion profile is created which is easy to manufacture and which, on the one hand, has increased rigidity and thus statics, and, on the other hand, provides a good insulation effect. With regard to the foam material according to the disclosure, in particular the PET foam, such as the Kerdyn® foam material, or the wingo-HT-isolation foam, it has surprisingly still been found that the insulation core can be screw-connected to the extrusion profile, in particular to its inner profile walls and/or to a profile wall forming the outer sides of the extrusion profile. This means that the foam material used according to the disclosure, in particular the PET foam material, such as the Kerdyn® material, or the wingo-HT-isolation foam, has sufficient resistance to the screw pulling out and/or tearing out. Additional bonding of the insulation core to the profile walls of the extrusion profile is not necessary. As a result, the foam material can be processed with conventional woodworking machines, so that a particularly simple shaping as possible without requiring special tools and/or machines.

The wingo-HT insulation foam is generally a high-temperature foam that can have a bulk density in the range from 100 kg/m³ to 200 kg/m³, in particular in the range from 120 kg/m³ to 180 kg/m³ or in the range from 140 kg/m³ to 160 kg/m³. A thermal conductivity according to DIN EN ISO 12667/10456 is less than 0.05 W/(mK), in particular at most 0.041 W/(mK) or 0.035 W/(mK), for example 0.031 W/(mK). A water absorption according to ISO 62 can be less than 5%, in particular less than 4%, 3%, 2% or 1%. Another advantage is the high temperature resistance from −40° C. to 220° C.

In an exemplary embodiment of the profile according to the disclosure, a stiffening profile, for example U-shaped or C-shaped stiffening profile, in particular of metal, such as steel, is arranged in the at least one hollow chamber. The stiffening profile may have a constant cross section in the longitudinal direction and/or be thin-walled. This means that a wall thickness of the stiffening profile walls may be significantly smaller in dimension than the outer cross-sectional dimension and/or the longitudinal dimension. For example, the stiffening profile is form fitted with respect to the hollow chamber. For example, the stiffening profile may abut 2, 3 or 4 profile walls delimiting the hollow chamber. The stiffening profile may be hollow and thus delimit or form profile chamber, and the insulation core may be arranged in the profile chamber of the stiffening profile. For example, the insulation core and the stiffening profile are preassembled and placed together in the hollow chamber. Alternatively, it is possible to first insert the stiffening profile into the hollow chamber and subsequently insulation core into the profile chamber of the stiffening profile. In an exemplary embodiment, the insulation core occupies the profile chamber substantially completely, in particular for more than 90%, in particular for more than 95% or for more than 98%. The application of a stiffening profile has in particular shown to be advantageous in applications of the extrusion profile in which particularly high requirements are placed on the statics and/or screw-resistance.

In an exemplary embodiment of the extrusion profile according to the disclosure, the foam material has a minimal compressive strength of 0.5 N/mm², 0.75 N/mm², 1.0 N/mm², 1.25 N/mm², 1.5 N/mm², 1.75 N/mm², 2 N/mm², 2.25 N/mm², 2.5 N/mm², 2.75 N/mm², or 3 N/mm². The values of the compressive strength are determined with the measuring method according to ASTM D 1621.

According to a further exemplary embodiment of the extrusion profile according to the disclosure, the foam material has a thermal conductivity of less than 0.05 W/(mK), in particular at most 0.041 W/(mK) or 0.035 W/(mK). The thermal conductivity can be determined using the standard DIN 12667 “thermal technical behavior of building materials and building products—determination of the thermal resistance using the plate device method with the heat flow measuring plate device products with high and medium thermal resistance”, and the thermal transmittance using DIN EN ISO 6946 “building components—thermal resistance and thermal transmittance—calculation method”. The heat transfer coefficient, also called the U-value, is a measure of the heat transfer through a solid body from a fluid. In relation to a window and/or a door, it indicates the heat flow, i.e. a heat energy per unit time, per area from the door and/or window and per Kelvin temperature difference inside a building and outside of the building. Thermal conductivity is generally a material property that determines the heat flow through a material due to thermal conduction. In general, the lower the thermal conductivity, the better it's thermal insulation. By means of the foam material used, as U-value in the range of 0.7 to 1.3 W/(m²K) can be achieved for a window and/or door. Due to the selected materials and properties, the extrusion profile according to the disclosure has particularly good thermal insulation properties, so that it is particularly suitable for passive houses. In principle, it is conceivable to use phones with the thermal conductivity of less than 0.1 W/(mK).

In another exemplary embodiment of the present disclosure, the firm has an axis-parallel screw extraction resistance, measured at a thickness of the insulation core of about 20 mm, of at least 100 N, in particular of at least 150 N, 200 N or of at least 210 N. The screw extraction resistance can be determined on the basis of standard EN 320. The screw extraction resistance is a generally a measure of the force required to extract a defined screw from the test specimen, in this case the foam insulation core. Surprisingly, it has been found that contrary to the prejudice that foam materials cannot be screwed to extrusion profiles, the foam material used according to the disclosure can be sufficiently reliably screwed to the profile walls, in particular of a polymer material. Additional bonding or gluing or the like is not necessary. Thus, in particular, assembly is facilitated as well as recycling is improved.

According to another axillary embodiment of the extrusion profile according to the disclosure, the insulation core is inserted into the hollow chamber in the extrusion direction. The extrusion profile can thus be produced in a simple manner. An extrusion basis profile can be produced by extrusion, and in particular simultaneously or sequentially thereto, a foam material insulation core adapted in this respect can be produced and processed. Subsequently, the foam insulation core can be inserted, in particular pushed, into a whole chamber of the extrusion base profile in the extrusion or longitudinal direction. After the insulation core has been inserted translationally into the hollow chamber, the insulation core can be screwed to the extrusion base profile so that a rigid connection is established.

In another exemplary embodiment of the extrusion profile according to the disclosure, the insulation core is adapted in shape or shape-matched with respect to the hollow chamber. For example, an outer dimension of the insulation core may be matched with respect to an inner dimension of the hollow chamber. For example, an undersize may be present between the insulation core and the hollow chamber. Further, an exterior dimension of the insulation core may be smaller than an inner dimension of the hollow chamber. Alternatively or additionally, a particularly circumferential slot in the range of 0 mm to 1.5 mm viewed with respect to the extrusion direction, may be present between an exterior dimension of the insulation core and an interior dimension of the hollow chamber. Thereby it is possible that the insulation core occupies at least 90% and/or no more than 100% of the world chamber. At an inner side of profile wall delimiting the hollow chamber, facing towards the insulation core, at least one spacing can may be provided. In this case, the insulation core may engage the spacing can so that a gap of free space is present around the spacing cam between the insulation core and the profile wall.

In an exemplary embodiment of the extrusion profile according to the disclosure, the insulation core and the hollow chamber are shape-matched to one another, that an amplitude of movement of the insulation core in the hollow chamber in the crosswise direction with regard to the extrusion direction of maximally 3 mm, in particular maximally 2 mm or of maximally 1.5 mm, are permitted. The maximal amplitude of movement ascertains that the insulation core does not wobble or shake in the hollow chamber. It shall be clear that the edges of the insulation core can be rounded such that a larger distance between insulation core and hollow chamber can be present. Thereby, however, the maximal amplitude of movement between the insulation core and hollow chamber is nevertheless ascertained.

According to a further exemplary embodiment of the present disclosure, in a preassembly state there is an oversize of the insulation core with respect to the hollow chamber of up to 1.5 mm and/or of up to 10% of a hollow chamber cross-section. For example, the insulation core is axially pressed into the hollow chamber and/or fixed within the hollow chamber by means of pressing. In a further exemplary embodiment of the extrusion profile according to the disclosure, the insulation core is screw-connected to at least one profile delimiting the hollow chamber. For example, a countersunk screw may be used. For example, the screw is a countersunk in the profile wall. For example, the insulation core including the profile wall may be screwed to a building support, such as a building masonry.

According to an exemplary further development, the extrusion profile according to the disclosure comprises a plurality of hollow chambers, wherein in insulation core is arranged, in particular inserted, in at least two hollow chambers in each case. For example, if particularly high requirements are placed on statics and/or thermal insulation, at least two insulation cores can be used.

In another exemplary embodiment of the present disclosure, an attachment profile, such as a width expander profile, a shield profile, or a lining ledge profile, is connected to the extrusion profile or in the extrusion basis profile. The attachment profile can be manufactured by extrusion and/or have at least profile chamber extending in longitudinal direction, in particular extrusion direction, and delimited by attachment profile walls, in which an insulation core of the foam material, in particular PET, such as Kerdyn®, or wingo-HT-isolation foam, having a compressive strength of at least 0.3 N/mm² is arranged. The profile chambers do substantially not change their cross-section and/or their dimensions in the longitudinal, in particular extrusion direction, and are designed opened towards at least one side with respect to the extrusion direction.

According to an exemplary further development, the attachment profile and of the extrusion profile have a fastening structure for positively and/or frictionally attaching to each other. For example, the fastening structure can comprise latching and/or hooking means. For example, the fastening structure is produced in one manufacturing step and/or from one piece with the remaining extrusion profile or attachment profile, in particular produced by an injection molding process, in particular from a polymer material.

In a further exemplary embodiment of the extrusion profile according to the disclosure, the hollow chamber and the insulating core are attached to each other, for example, by a force fit, a form fit and/or a material fit. The fastening can be realized, for example, by screwing, pinning or by other suitable fastening means, such as clips, sleeves or the like. In addition, material-locking fastenings are possible. For example, the insulating core can be bonded or glued to the hollow chamber, for example by means of wet bonding or dry bonding. One advantage of fastening the hollow chamber and the insulating core is that the extrusion profile can be handled more easily. For example, an insulation core up to 7 m long can be inserted into the hollow chamber and then attached. Such an extrusion profile can then be handed over to a window manufacturer or the like, ensuring that the hollow chamber and insulation core are fastened together. Another advantage is that the insulation core and hollow chamber can be cut, for example by sawing, to size at the same time. Cores with individually cut lengths are no longer necessary. This results in a considerable cost-saving potential. Furthermore, the material used for the foam core allows the hollow chamber and the insulating core to be corner-welded at the same time. This means that the corner strength can be increased by welding the insulation core over the entire surface. Furthermore, the insulation values are improved by a circumferential weld.

In an exemplary embodiment, the hollow chamber and the insulating core are attached to one another by a mechanical force input, for example by knurling, in particular from the outside, i.e. from the hollow chamber, and/or by a thermal energy, in such a way that the hollow chamber and the insulating core engage each other, in particular interlock and/or hook, as a result of a deformation of the hollow chamber and the insulating core resulting from the mechanical force input and/or thermal heat input. For example, the hollow chamber can be deformed by a mechanical force input from the outside in such a way that a fastening lug is formed which extends into the material of the insulating core. Furthermore, it is possible to create an attachment via the resulting perforation structure, in particular from the outside, i.e. from the hollow chamber, of the hollow chamber and at least partially of the insulating core, by means of punctual perforation. The perforations can then be welded or closed with another filling material, for example an end cap, or filled with plastic material by means of a hollow needle, for example with or without heating the material of the hollow chamber.

According to a further aspect of the present disclosure, which can be combined with the preceding aspects and exemplary embodiments, a method for manufacturing an extrusion profile, in particular according to the disclosure, is provided. The extrusion profile can be made, for example, of the polymer material, such as PVC, and can be used for a door system and/or a window system, for example of the passive house.

In the manufacturing process according to the disclosure, an extrusion basis profile having at least one hollow chamber extending in the extrusion direction and delimited by profile walls is manufactured by means of extrusion, in particular a polymer material extrusion. In the extrusion direction, the cross-section of the hollow chamber and/or of the extrusion basis profile does not substantially change. Furthermore, the hollow chamber may be designed to be open towards at least one side.

According to the disclosure, an insulating core made of foam, in particular PET, such as Kerdyn®, or the wingo-HT-isolation foam, which has a compressive strength of at least 0.3 N/mm², is inserted, in particular pushed, into the hollow chamber in the extrusion direction.

According to an exemplary embodiment of the method of the disclosure, the method is adapted to produce an extrusion profile formed according to any of the previously described aspects and/or exemplary embodiments.

According to a further aspect of the present disclosure, which may be combined with the preceding aspects and exemplary embodiments, a door system and/or window system is provided, for example for a passive house. The door system and/or window system comprises at least one extrusion profile sectionally forming a profile frame and/profile attachment part of the door and/or window, which extrusion profile is formed according to one of the previously described aspects and/or exemplary embodiments and/or is produced by manufacturing process according to the disclosure.

In the following description of exemplary embodiments of the present disclosure, an extrusion profile according to the disclosure is generally designated with reference numeral 1. For the further description it may be understood that the extrusion profiles 1 are made of a polymer material, such as PVC, through an extrusion process. The extrusion direction E is thereby oriented in the drawing plane. The extrusion profiles 1 according to the disclosure are used in doors or windows, in particular in door frames or window frames. For example, the extrusion profile 1 may be a frame profile, sash profile, a width expander profile of the sash or of a frame, a mullion profile, a shield profile, a shield sash profile, a shroud profile, in particular in sliding doors or windows, or a lining ledge profile.

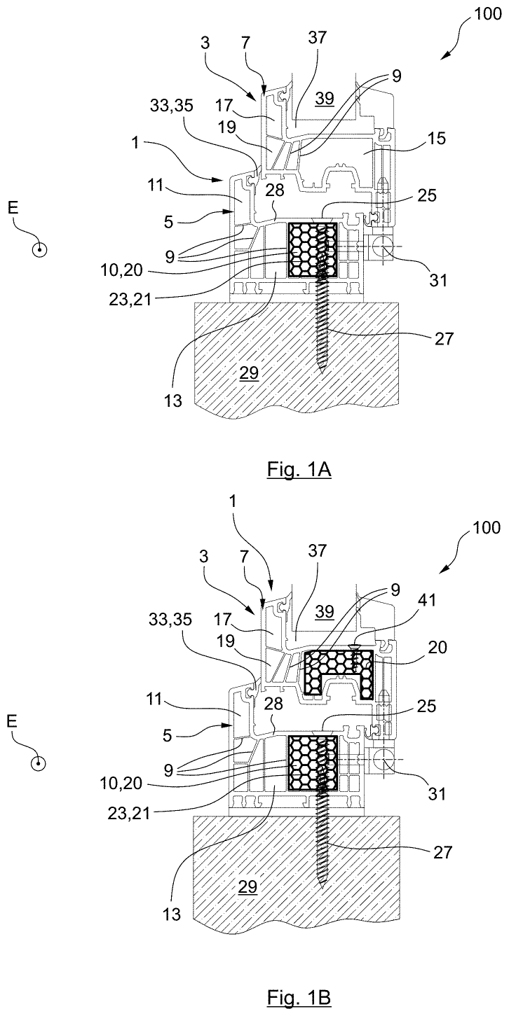

In the exemplary embodiments of FIGS. 1A to 9B, the extrusion profiles 1 according to the disclosure are always illustrated as part of the door system or window system 100. In this context another profile which may also be manufactured by extrusion, for example of a polymer material, such as PVC, and which cooperates with the extrusion profile 1 according to the disclosure as a component of the door system or window system 100 is generally provided with the reference numeral 3.

The extrusion profile according to the disclosure, as well as the extruder profile 3, has a circumferential wall 5 or 7 forming an outside of the profile, which defines a substantially constant cross-section or outer shape is viewed in the extrusion direction E. Internally, the extrusion profile 1 and the extruded profile 3 may in particular have thin-walled profile webs or profile walls 9 which, together with another profile wall 9 and/or the outer wall 5, 7, define hollow chambers 10, 13, 15, 17, 19, 21, 47, 67, 91, 93, 95, 81. The hollow chamber is generally indicated with reference numeral 10, individual hollow chambers may be indicated with a further reference numeral. The profile walls 9 hollow chambers 10 can be produced in a simple manner by means of the extrusion process.

The extrusion profile 1 according to an exemplary embodiment of the disclosure has an insulation core 20 of the material arranged in 1 of the hollow chambers 10, namely in the hollow chamber 21, which core has a compressive strength of at least 0.3 N/mm². An insulation core is generally indicated by the reference numeral 20, and individual insulation cores may be indicated by further reference numeral. For example, the insulation core 20 comprises PET, such as Kerdyn®, in particular Kerdyn® 115, or the wingo-HT-isolation foam. The inventors of the present disclosure found that by using a foam insulation core having the predetermined compressive strength of at least 0.3 N/mm 2, the extrusion profiles 1 according to the disclosure, when used in doors or windows, in particular of passive houses, ensure as well as the requirements in terms of statics and in terms of insulation property. A significant advantage is that additional stiffening means, such as metal stiffeners of fasteners, can be dispensed with.

As can be seen in FIG. 1A, the insulation core 20, 23 is screwed into the extruder profile 1. For this purpose, screw 25 is screwed from the outside, for example with a screw 25 attached in the region of the profile wall 27 facing the extruded profile 3, which screw projects into the hollow chamber 23 and is screwed into the foam insulation core 23. Due to the screwability or screw strength of the foam materials used for the insulation core 20, a screw connection is possible so that gluing or other material bonding between the insulation core 23 of the profile wall 5 can be dispensed with. The aspect enables simple and environmentally friendly recycling of the extrusion profiles 1. The extrusion profiles 1 according to the disclosure are manufactured in simple manner. First, an extrusion profile basis produced in an extrusion die, and then the insulation core 20 is inserted into a predetermined hollow chamber 10, in particular inserted in the extrusion direction E. It should be understood that an outer dimension of the insulation core 20 is shape-matched with respect to an inner dimension of the corresponding hollow chamber 10. In this way, it is possible to dimension the insulation core 20 precisely with respect to the hollow chamber 10 no waste is produced of the process, as the foam material allows sections of any axial length to be produced and joined together, for example to be backed welded together, without the need for adhesives.

As can be seen in FIG. 1A, the extrusion profile 1 according to the disclosure is attached by means of a screw 27 to a building support 29, which may for example be a house wall. To the extrusion profile 1, which according to FIG. 1A is a stationary door a window system component, there is pivotably attached and extruded profile 3 which forms the movable leave of the door or window system 100. The pivotable connection between the stationary extrusion profile 1 and extruded profile 3, which is pivotable with respect thereto, is implemented by pivot joint, which is schematically indicated by the reference design 1. In the seam area 33 between the extrusion profile and the extruded profile 3, a sash seal 35 is provided for sealing. Furthermore, the extruded profile has a glazing 39 received in a glazing groove 37 such as a glazing rebate.

FIG. 1B shows essentially the same door or window system 100 as in FIG. 1A, with the difference that the extruded profile 3 is also designed as an extrusion profile 1 according to the disclosure. As can be seen in FIG. 1B, an insulation core 20 made of foam material with a compressive strength of at least 0.3 N/mm² is also inserted into the hollow chamber 15, which has a substantially you—shaped cross-sectional shape. This insulation core 20 is also screwed to the extrusion profile base by means of a screw 41.

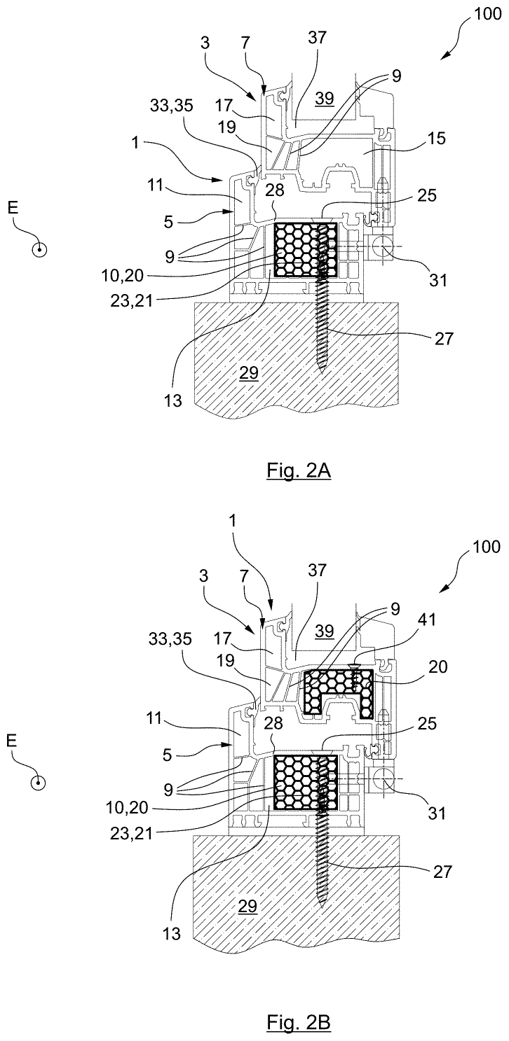

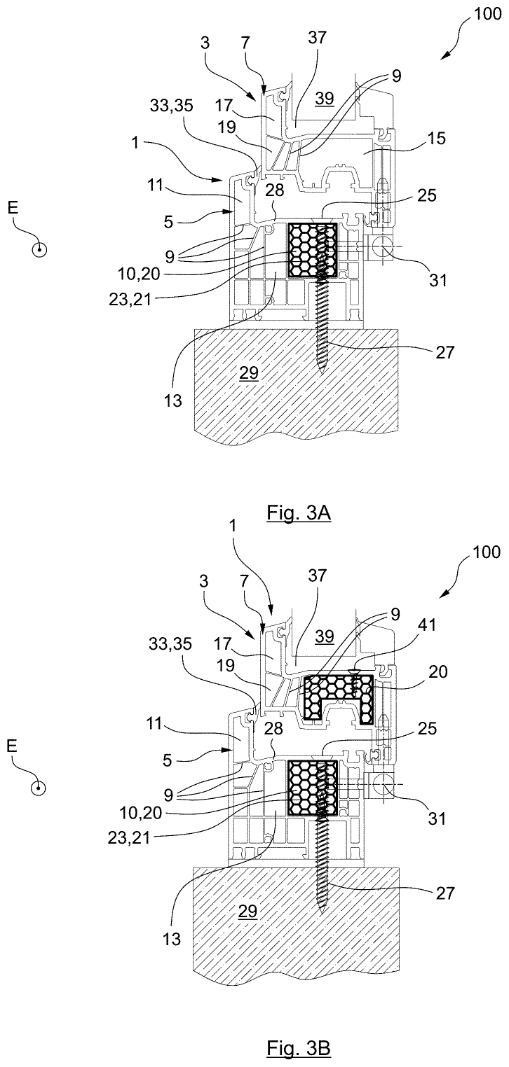

FIGS. 2A, 2B and 3A, 3B respectively show analogous door or window systems 100 wherein in each case the embodiment of variant a consists of an extrusion profile 1 according to the disclosure and an extruded profile 3, while the embodiment the variant b consists of 2 extrusion profiles 1 according to the disclosure. Accordingly, reference can be made to the embodiments with relation to FIGS. 1A and 1B. As can be seen from comparison of FIGS. 1, 2, 3, the extrusion profiles 1 differ essentially in terms of dimensioning. In FIGS. 2A and 2B, the hollow chamber 21 for the insulation core 23 is significantly larger in size so that the insulation core 23 itself may also be large in size, in order to fill the whole chamber 21 as well as possible. In FIGS. 3A, 3B, the profile wall 3 of the extrusion profile 1 according to the disclosure is dimensioned to be larger transversely to the extrusion direction E.

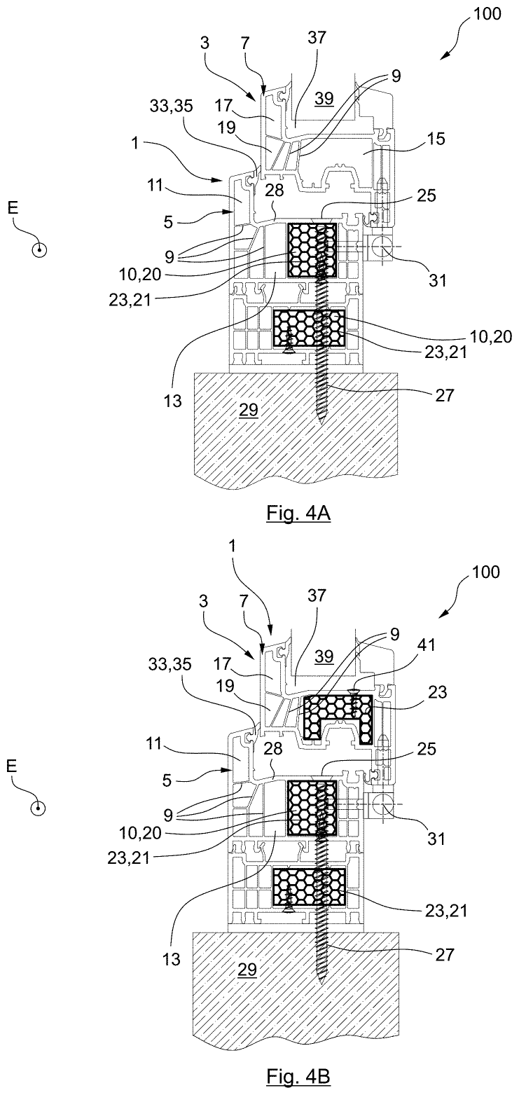

The embodiment of the door and/or window system according to FIGS. 4A, 4B is a substantially based on the door and/or window system 100 according to FIGS. 1A, 1B. In contrast to the embodiment according to FIGS. 1A, 1B, the door and/or window system 100 according to figures FIGS. 4A, 4B comprises an additional width extender profile 43 arranged between the building support 29 in the stationary extrusion profile 1 according to the disclosure. The width expander profile 43 is further configured as an extrusion profile according to the disclosure and has a circumvention profile wall 45 with a plurality of profile walls 49 dividing the hollow profile wall 45 into a plurality of hollow chambers 47. The widening profile 43 according to the disclosure is coupled to the extrusion profile 1 according to the disclosure via a latching or hooking structure 51, wherein latching logs or latching hooks 53 engage with each other into a plurality of hollow chambers 47. The widening profile 43 according to the disclosure is coupled to the extrusion profile 1 according to the disclosure via a latching or hooking structure 51, wherein latching logs a latching hooks 53 engage with each other to secure the profiles 43, 1 together. The width expander profile 43 according to the disclosure further comprises a hollow chamber 55 of larger dimensions with respect to the other hollow chambers 47, in which the foam insulation core having a compressive strength of at least 0.3 N/mm² is inserted, which is again screwed to the profile wall 45 by means of a screw 57. Furthermore, the hollow chamber 55 is insulation core arranged therein are positioned with respect to the hollow chamber 21 the insulation core 23 is arranged therein such a way that the fastening screw 27 extends, starting from the profile wall 27 of the extrusion profile 1 according to the disclosure, through the hollow chamber 21 the insulation core 23 arranged therein and also through the hollow chamber 55 and the insulation core 59 arranged therein, into the structural support member 29 fastening both the extrusion profile 1 according to the disclosure and the widening profile 43 according to the disclosure.

In FIG. 4B it can be seen, in a manner analogous to FIG. 1B, that the extruded profile 3 forming the sash is also designed as an extrusion profile 1 according to the disclosure the foam insulation core.

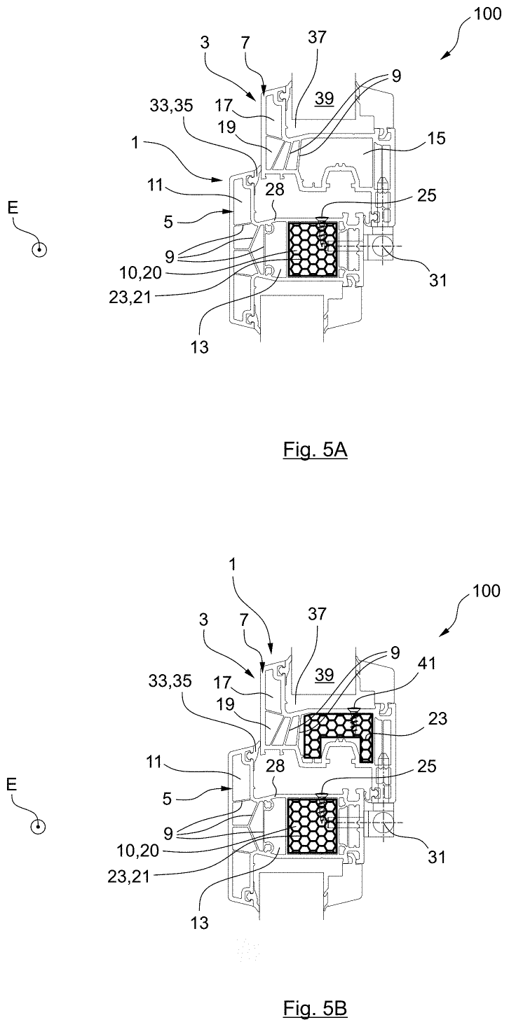

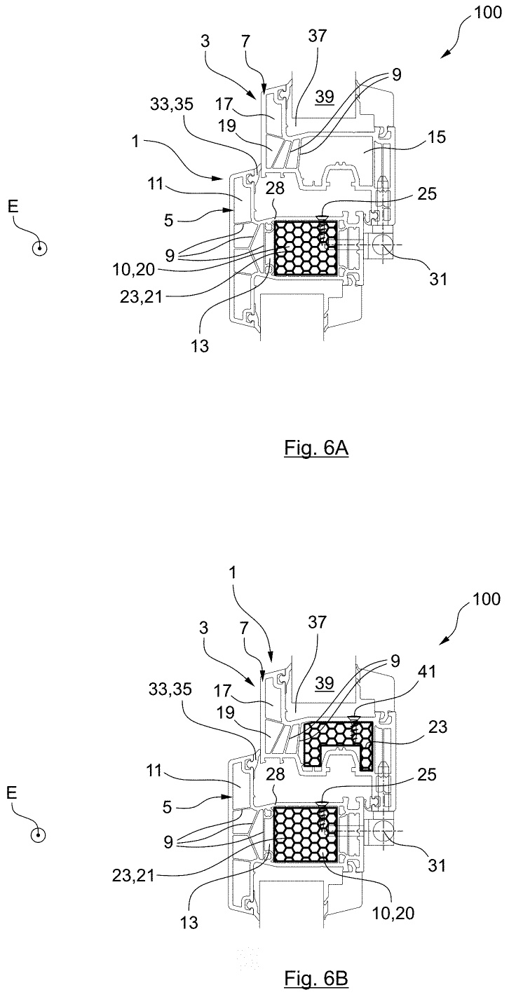

FIGS. 5A, 5B and 6A, 6B, respectively, show exemplary embodiments of the door and/or window systems 100 in which the extrusion profile 1 according to the disclosure is designed as a Morgan profile and has a glazing rebate 63 to which a glazing 65 is inserted. The extrusion profile 1 according to the disclosure cooperates with an extruded profile 3 forming the sash, which according to the embodiment variant b is also configured as an extrusion profile 1 according to the disclosure.

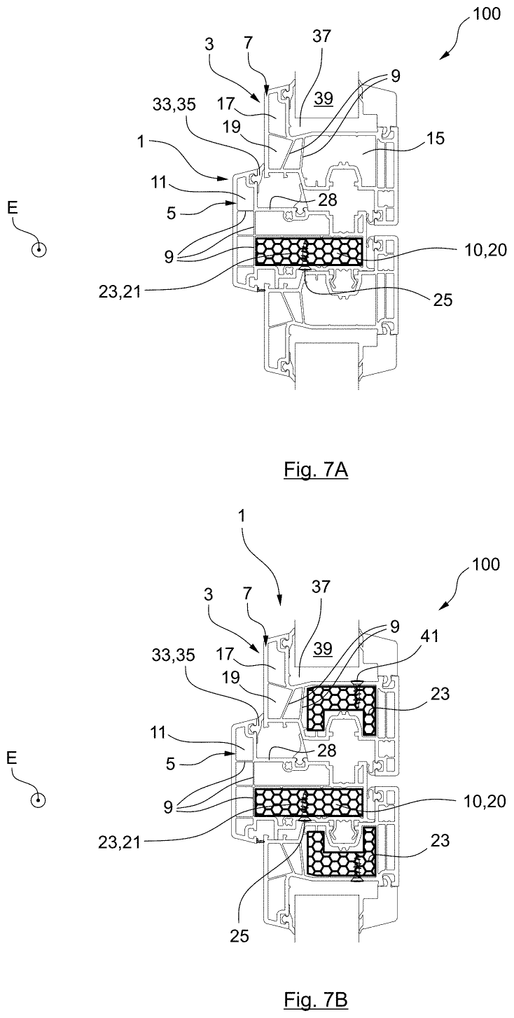

FIGS. 7A, 7B show an embodiment of the door and/or window system 100 in which, in addition to two extruded profiles 3 each forming a sash, the shield profile 61 is arranged in the same area of the 2 sash profiles 3. The shield profile 61 is substantially L-shaped cross-section and covers the visible face side indicated by reference signer 63, and comprises a foam insulation core 65 in a substantially rectangular hollow chamber 67.

In embodiment variant b, the extruded profiles 3 forming the sash is are also designed as extrusion profiles 1 according to the disclosure and have foam insulation cores.

FIG. 8 shows a door and/or window system 100 comprising two extrusion profiles 1 according to the disclosure, 1 of which forms a sash 69 and the other 1 shield 71. Both extrusion profiles 1, 69, 71 according to the disclosure have a foam insulation core of L-shaped cross-section, which is screwed to the respective profile. From the visible face side 63, a cuff 73 covers the same area of the two extrusion profile 69, 79 according to the disclosure.

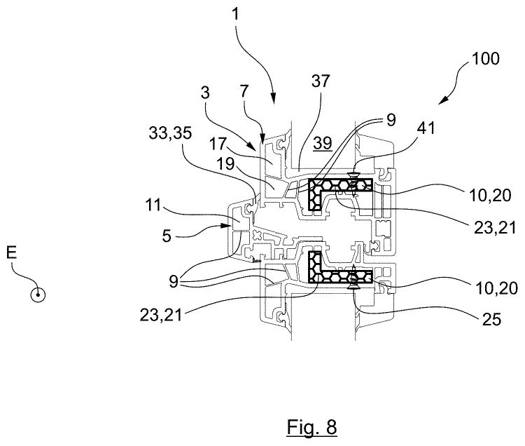

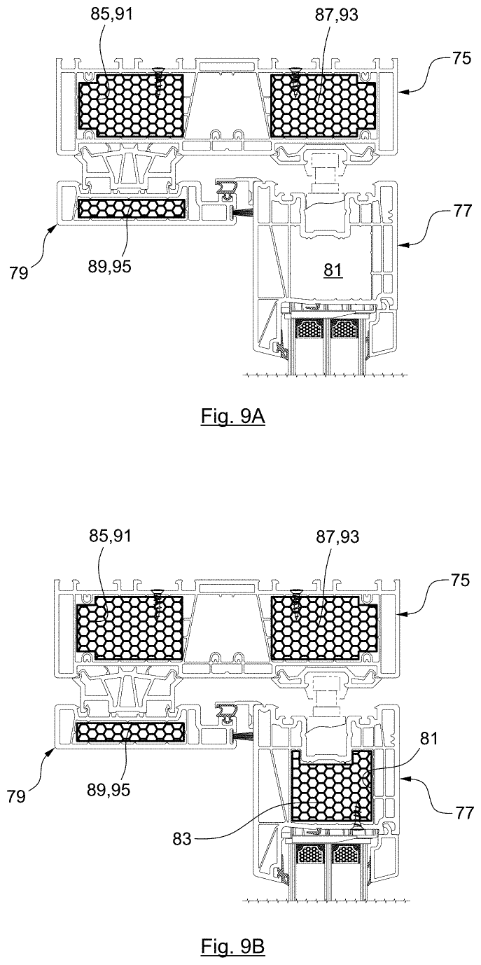

The embodiment of the door and/or window system 100 of FIGS. 9A, 9B relates to a sliding door and/or sliding window system, in particular a lift-slide door and/or a lift-slide window system. The sliding system 100 comprises as main components: a frame 75; a sash 77; a lining ledge 79. The embodiments 9A, 9B differ essentially that, according to FIG. 9B, the sash profile 77 is designed as an extrusion profile 1 according to the disclosure and has a central foam insulation core 83 with a compressive strength of at least 0.3 N/mm², which is arranged in a central hollow chamber 81 and is screwed to the profile 77. In both embodiments 9A, 9B, the main components, namely the frame profile 75 and the lining ledge profile 79 comprise foam insulation cores 85, 87, 89 Houston respective hollow chambers 91, 93, 95 and each being screw connected to the corresponding profile.

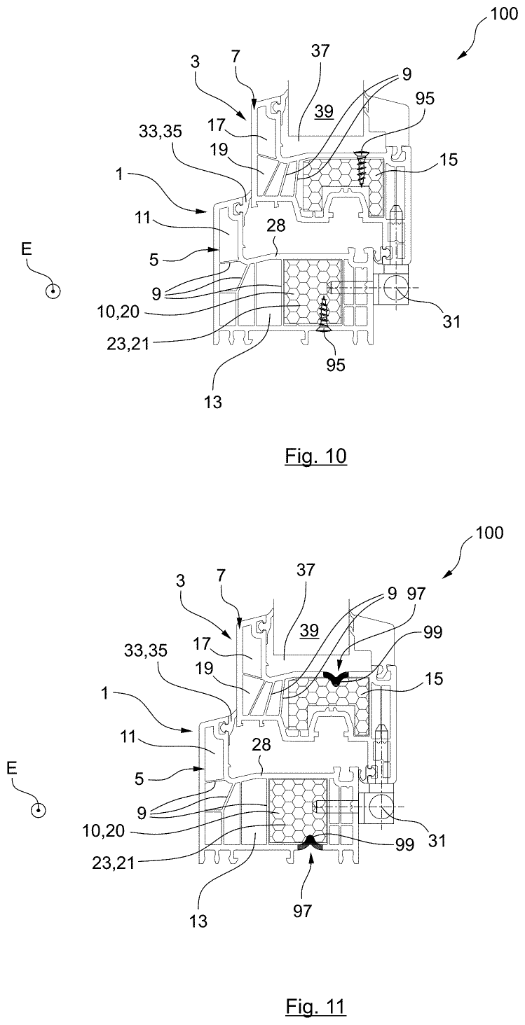

The schematic sectional views of extrusion profiles 1 according to exemplary embodiments of the disclosure in FIGS. 10 to 15 are used to describe possible fastening variants for the insulating core 20 and hollow chamber 10. To avoid repetition, reference is made to the previous explanations with regard to the structures and materials of the components of the extrusion profile 1, and only the fastening variants are referred to in the western section.

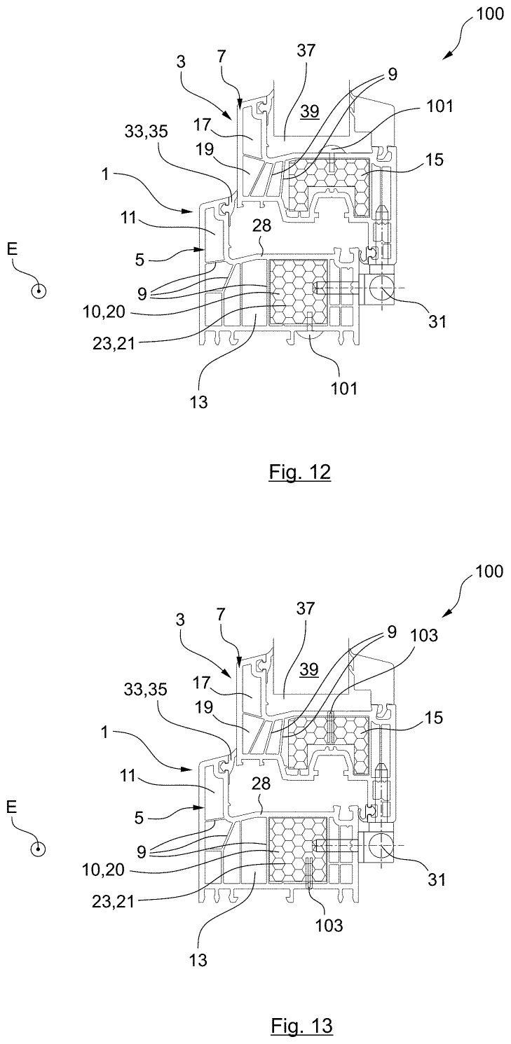

In FIG. 10, the two illustrated insulating cores 20 are fixed to the respective hollow chamber 10, in which the two insulating cores 20 are respectively arranged, in particular inserted, by means of a respective fastening screw 75. Alternative fastening means, such as pinning 101 or fastening clips 103, are shown in FIGS. 12 and 13.

In FIG. 11, a so-called deformation fastening 97 has been produced. For this purpose, the hollow chamber 10 has been locally deformed by a mechanical force application from the outside and/or thermal heat application in such a way that a fastening lug 99 is formed, which extends into the material of the insulating core 20.

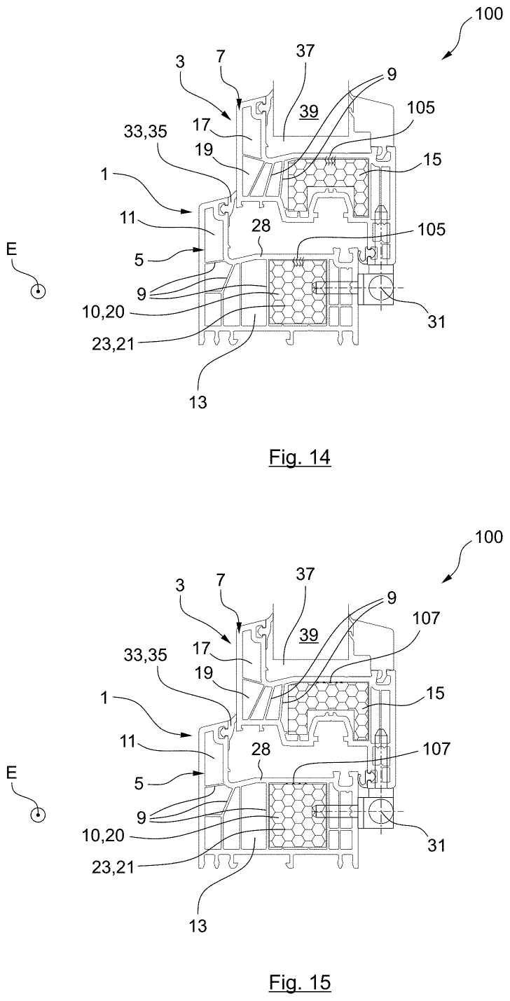

FIGS. 14 and 15 show further alternative fastening variants. In FIG. 14, the insulating cores 20 and the hollow chamber 10 are bonded together, with an adhesive schematically indicated by the numeral 105. In FIG. 15, no further fastening means are necessary. The insulation core 20 and the hollow chamber 10 are fastened to each other by a form fit and/or force fit, which according to FIG. 15 is realized by a press fit, indicated by the reference sign 107.

The features disclosed in the above description, figures and claims may be of relevance, both individually and in any combination thereof, for the realization of the disclosure in its various embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 extrusion profile
3 extruded profile
5, 7 profile wall
9 profile wall
10, 11, 13, 15,17,19, 21, 47, 67, 91, 93, 95, 81 hollow chamber
20, 22, 55, 65, 85, 87, 89, 83 insulation core
25 screw
27 fastening screw
28 profile wall
29 building support
31 swivel joint
33 seam area
35 seal
37 glazing seal
39 glazing
41 screw
43 width expander profile
45 profile wall
51 hooking structure
53 latching hooks
57 screw
62 glazing rebate
64 glazing
61, 71 shield profile
63 face area
69 sash profile
73 shield
75 frame profile
77 sash profile
93 lining profile
95 screw
97 deformation fastening
99 fastening lug
101 pin
103 fastening clip
105 glue
107 press fit
E extrusion direction

1. An extrusion profile for a door system and/or window system, comprising:
at least one hollow chamber extending in an extrusion direction, the at least one hollow chamber being delimited by profile walls; and
an insulation core of foam having a compression strength of at least 0.3 N/mm² being arranged in the at least one hollow chamber.

2. The extrusion profile according to claim 1, wherein the foam has minimal compression strength of 0.5 N/mm², 0.75 N/mm², 1.0 N/mm², 1.25 N/mm², 1.5 N/mm², 1.75 N/mm², 2 N/mm², 2.25 N/mm², 2.5 N/mm², 2.75 N/mm² or 3 N/mm².

3. The extrusion profile according to claim 1, wherein the foam has a heat conductivity of less than 0.05 W/(mK).

4. The extrusion profile according to claim 1, wherein the foam has an axially parallel screw pull-out resistance of at least 100 N measured at a thickness of the insulation core of 20 mm.

5. The extrusion profile according to claim 1, wherein the insulation core is inserted into the hollow chamber in the extrusion direction.

6. The extrusion profile according to claim 1, wherein the insulation core and the hollow chamber are shaped to match one another such that a maximum permitted amplitude of movement of the insulation core in the hollow chamber crosswise, with respect to the extrusion direction, is 3 mm.

7. The extrusion profile according to claim 1, wherein the insulation core is adapted in shape with respect to the hollow chamber, an undersize being present between the insulation core and the hollow chamber, wherein:
an exterior dimension of the insulation core is smaller than an inner dimension of the hollow chamber, and/or
circumferential slot between 0 mm and 1.5 mm is present between an exterior dimension of the insulation core and an inner dimension of the hollow chamber.

8. The extrusion profile according to claim 1, wherein an oversize of the insulation core with respect to the hollow chamber of up to 1.5 mm is present in a pre-assembly state.

9. The extrusion profile according to claim 1, wherein the insulation core is screw connected to at least one of the profile walls delimiting the at least one hollow chamber.

10. The extrusion profile according to claim 1, wherein an attachment profile is attached to the extrusion profile, being manufactured through extrusion and/or comprising at least one profile chamber extending in the extrusion direction, and being delimited by attachment profile walls, in which an insulation core of foam is arranged having a compression strength of at least 0.3 N/mm².

11. The extrusion profile according to claim 10, wherein the attachment profile and the extrusion profile comprise a fastening structure configured to positively and/or frictionally attach to each other.

12. The extrusion profile according to claim 1, wherein the insulation core and the hollow chamber are attached to each other.

13. The extrusion profile according to claim 1, wherein the insulation core and the hollow chamber are attached to each other by screwing, pinning, gluing, knurling, perforating and/or form fitting.

14. The extrusion profile according to claim 1, wherein the hollow chamber and the insulation core are attached to each other, by a mechanical force and/or thermal energy, such that the hollow chamber and the insulation core are configured to engage each other in a catching and/or interlocking manner due to a deformation of the hollow chamber and the insulation core resulting from the mechanical force and/or thermal energy.

15. The extrusion profile according to claim 1, wherein the extrusion profile is of a polymer material.

16. A method for manufacturing an extrusion profile for a door system and/or window system, the method comprising:
forming, by extrusion, an extrusion profile with at least one hollow chamber extending in an extrusion direction, the extrusion profile being delimited by profile walls; and
inserting an insulation core of a foam material having a compressive strength of at least 0.3 N/mm² into the at least one hollow chamber.

17. The method according to claim 16, wherein the extrusion profile formed by extruding a polymer material.

18. A door system and/or window system, comprising:
at least one extrusion profile that includes:
at least one hollow chamber extending in an extrusion direction, the at least one hollow chamber being delimited by profile walls; and
an insulation core of foam having a compression strength of at least 0.3 N/mm² being arranged in the at least one hollow chamber,
wherein the at least one extrusion profile at least sectionally forms a frame of the door and/or window.
